(19) United States
(12) Patent Application Publication
(10) Pub. No.: US 2015/0246342 A1
(43) Pub. Date: Sep. 3, 2015

(54) CATALYST FOR HYDROCARBON REFORMING, METHOD OF MANUFACTURING THE SAME, AND METHOD OF MANUFACTURING SYNTHESIS GAS

(71) Applicants: SUMITOMO CHEMICAL COMPANY, LIMITED, Tokyo (JP); SHOEI CHEMICAL INC., Tokyo (JP); NATIONAL UNIVERSITY CORPORATION OITA UNIVERSITY, Oita-shi (JP)

(72) Inventors: Kazuro NAGASHIMA, Tosu-shi (JP); Katsutoshi NAGAOKA, Oita-shi (JP); Katsutoshi SATO, Oita-shi (JP); Hideyuki HIGASHIMURA, Tsukuba-shi (JP)

(73) Assignees: SUMITOMO CHEMICAL COMPANY, LIMITED, Tokyo (JP); NATIONAL UNIVERSITY CORPORATION OITA UNIVERSITY, Oita-shi (JP); SHOEI CHEMICAL INC., Tokyo (JP)

(21) Appl. No.: 14/631,980

(22) Filed: Feb. 26, 2015

(30) Foreign Application Priority Data
Mar. 3, 2014 (JP) 2014-040503

(51) Int. Cl. B01J 23/755; B01J 23/75; C01B 3/40; B01J 37/02; B01J 37/08; B01J 37/00; B01J 23/02; B01J 35/02

(52) U.S. Cl. CPC B01J 23/755; B01J 23/02; B01J 23/75; B01J 35/026; B01J 37/0234; B01J 37/08; B01J 37/0072; C01B 3/40; C01B 2203/0238; C01B 2203/1052; C01B 2203/1058; C01B 2203/1082

(57) ABSTRACT

There is provided a catalyst for hydrocarbon reforming having a high deposition suppressing effect with respect to a carbonaceous material on the catalyst surface even in a case where a reforming material including carbon dioxide, in particular, formed of only carbon dioxide is used in a reforming reaction, a method of manufacturing the same, and a method of manufacturing a synthesis gas using the catalyst. Specifically, there is provided a catalyst for hydrocarbon reforming which is a catalyst for reforming used for reforming hydrocarbons by a reaction of the hydrocarbons and a reforming material including carbon dioxide in which at least one type of metal particles selected from cobalt particles and nickel particles is supported on a support formed of magnesia in which an aluminum-containing component is segregated on the surface; and a method of manufacturing a synthesis gas in which using the catalyst for hydrocarbon reforming, a synthesis gas including carbon monoxide and hydrogen is obtained from a reforming material including hydrocarbons and carbon dioxide.

### BACKGROUND OF THE INVENTION

1. Field of the Invention

The present invention relates to a novel catalyst for hydrocarbon reforming, a method of manufacturing the same, and a method of manufacturing a synthesis gas including carbon monoxide and hydrogen using the catalyst.

Priority is claimed on Japanese Patent Application No. 2014-040503, filed Mar. 3, 2014, the contents of which are incorporated herein by reference.

2. Description of Related Art

When hydrocarbons included in methane, natural gas, petroleum gas, naphtha, heavy oil, crude oil, and the like are reacted with a reforming material including carbon dioxide in the presence of a catalyst in a high temperature range (reforming reaction), a reformed mixed gas (synthesis gas) having a relatively low molar ratio of hydrogen/carbon monoxide is obtained. The mixed gas is useful as a raw material for methanol, a light hydrocarbon, or liquid fuel oil.

However, in a case where a reforming material including carbon dioxide is used, there is a problem that carbonaceous material is likely to be deposited on the catalyst surface during the reforming reaction. The deposited carbonaceous material not only decreases the catalytic activity by covering the active sites of the catalyst surface but also causes clogging of the catalyst, damage of the catalyst layer, or the like, and decreases the proportion of the catalyst contributing to the reforming reaction by making the gas in the reaction zone drift.

As means in order to suppress the deposition of carbonaceous material in such a reforming reaction, a catalyst for hydrocarbon reforming in which a catalytically active component has been highly dispersed (reforming catalyst), and the method of manufacturing the same have been disclosed (refer to JP 2002-126528 and JP 2004-141860).

More specifically, JP 2002-126528 discloses a catalyst for hydrocarbon reforming which is obtained by precipitating hydroxide by adding a coprecipitating agent to an aqueous solution containing a catalyst constituent element, and drying and baking the hydroxide.

In addition, JP 2004-141860 discloses a catalyst for hydrocarbon reforming which is obtained by dipping a porous forming body for constituting a support in an aqueous solution including a catalytically active component and a support constituting component for supporting the catalytically active component, impregnating the porous forming body with the above respective components, and baking this at high temperature.

### SUMMARY OF THE INVENTION

However, in a case where a reforming reaction is performed using the catalysts for hydrocarbon reforming disclosed in JP 2002-126528 and JP 2004-141860, for example, when the reforming material is a material having a ratio of carbon dioxide/water=1/2.5 (molar ratio), the deposition of carbonaceous material in the reaction system is essentially small, and thus, the deposition of the carbonaceous material on the catalyst surface is suppressed to some extent. However, for example, in a case where the deposition of the carbonaceous material in the reaction system is essentially large such as a case where the reforming material is only carbon dioxide, there is a problem that the deposition suppressing effect with respect to carbonaceous material on the catalyst surface is not sufficient.

The invention has been made in consideration of the above circumstance, and an object of the invention is to provide a catalyst for hydrocarbon reforming having a high deposition suppressing effect with respect to carbonaceous material on the catalyst surface even in a case where a reforming material including carbon dioxide, in particular, formed of only carbon dioxide is used in the reforming reaction, a method of manufacturing the same, and a method of manufacturing a synthesis gas using the catalyst.

To solve the above problems, the present invention provides a catalyst for hydrocarbon reforming which is used for reforming hydrocarbons by a reaction of the hydrocarbons and a reforming material including carbon dioxide, and in which at least one type of metal particles selected from cobalt particles and nickel particles is supported on a support formed of magnesia in which an aluminum-containing component is segregated on the surface.

In the catalyst for hydrocarbon reforming of the present invention, the amount of the metal particles is preferably 0.001% by mass to 20% by mass with respect to the support.

In the catalyst for hydrocarbon reforming of the present invention, the amount of aluminum in the support is preferably 0.001% by mass to 10% by mass.

In the catalyst for hydrocarbon reforming of the present invention, the magnesia before the metal particles are supported is preferably in the form of a powder.

In addition, the present invention provides a method of manufacturing the catalyst for hydrocarbon reforming, in which a magnesia powder is impregnated with an aqueous solution in which an aluminum salt and at least one salt selected from a cobalt salt and a nickel salt are dissolved, the obtained impregnated material is dried, and the obtained dried material is baked and further reduced.

In addition, the present invention provides a method of manufacturing the catalyst for hydrocarbon reforming, in which an aqueous solution in which a magnesium salt, an aluminum salt, and at least one salt selected from a cobalt salt and a nickel salt are dissolved is sprayed, and the powder synthesized by heating the obtained liquid droplets is further reduced.

In addition, the present invention provides a method of manufacturing a synthesis gas in which using the catalyst for hydrocarbon reforming, the synthesis gas including carbon monoxide and hydrogen is obtained from hydrocarbons and a reforming material including carbon dioxide.

In the method of manufacturing a synthesis gas of the present invention, as the reforming material, it is preferable to use only carbon dioxide.

In the method of manufacturing a synthesis gas of the present invention, the hydrocarbons and the reforming material are preferably supplied such that the reforming material/the hydrocarbons (molar ratio) becomes 0.3 to 10.

In the method of manufacturing a synthesis gas of the present invention, the hydrocarbon is preferably methane.

According to the present invention, a catalyst for hydrocarbon reforming having a high deposition suppressing effect with respect to carbonaceous material on the catalyst surface even in a case where a reforming material including carbon dioxide, in particular, formed of only carbon dioxide is used in the reforming reaction, a method of manufacturing the same, and a method of manufacturing a synthesis gas using the catalyst are provided.

### BRIEF DESCRIPTION OF THE DRAWINGS

FIG. 1 is a graph showing a TPR (temperature-programmed reduction) analysis result for baked materials in Examples 1 to 3 and Comparative Example 1.

FIGS. 2A and 2B are composition analysis results in an EDX of a catalyst D in Test Example 2, and FIG. 2A is a distribution diagram of magnesium, and FIG. 2B is a distribution diagram of aluminum.

FIGS. 3A and 3B are composition analysis results in an EDX of a catalyst E in Test Example 2, and FIG. 3A is a distribution diagram of magnesium, and FIG. 3B is a distribution diagram of aluminum.

FIGS. 4A, 4B, and 4C are composition analysis results in an EDX of a baked material C′ in Test Example 3, and FIG. 4A is a distribution diagram of magnesium, FIG. 4B is a distribution diagram of aluminum, and FIG. 4C is a diagram obtained by superimposing the distribution diagram of magnesium and the distribution diagram of aluminum.

FIGS. 5A, 5B, and 5C are composition analysis results in an EDX of a baked material A′ in Test Example 4, and FIG. 5A is a distribution diagram of magnesium, FIG. 5B is a distribution diagram of aluminum, and FIG. 5C is a diagram obtained by superimposing the distribution diagram of magnesium and the distribution diagram of aluminum.

### DETAILED DESCRIPTION OF THE INVENTION

<Catalyst for Hydrocarbon Reforming>

The catalyst for hydrocarbon reforming (hereinafter, may be simply referred to as “catalyst”) according to the present invention is a catalyst used for reforming hydrocarbons by a reaction of the hydrocarbons and a reforming material including carbon dioxide, and a catalyst in which at least one type of metal particles selected from cobalt particles and nickel particles is supported on a support formed of magnesia (magnesium oxide) in which an aluminum-containing component is segregated on the surface.

In a reforming reaction of reacting hydrocarbons and a reforming material including carbon dioxide, the catalyst has a high deposition suppressing effect with respect to carbonaceous material on the surface thereof, exhibits high activity, and is extremely useful for the manufacture of a synthesis gas including carbon monoxide (CO) and hydrogen (H₂). The synthesis gas, for example, can be used in manufacture of light hydrocarbons by the Fischer-Tropsch reaction or manufacture of methanol, liquid fuel oils, or the like, and utility value thereof is extremely high. In addition, the catalyst has a high deposition suppressing effect with respect to carbonaceous material on the surface thereof, and thus, it is possible to maintain the high activity thereof for a long period of time.

Moreover, the term “carbonaceous material” in the present specification means carbon or a component having carbon as a main component, and as a typical carbonaceous material, fibrous carbon can be exemplified.

The reforming material and the hydrocarbons are the same as those described in the method of manufacturing a synthesis gas described below.

The metal particles supported on the support become an active component of the catalyst, and may be any one type of cobalt particles and nickel particles and may be both types of cobalt particles and nickel particles.

Although the ratio of the cobalt particles to the nickel particles supported on the support is not particularly limited and can be arbitrarily adjusted, the metal particles supported on the support are preferably either only the cobalt particles or only the nickel particles.

By segregation of an aluminum-containing component on the support surface, the metal particles have smaller particle diameters, and become finer particles than in a case where an aluminum-containing component is not segregated on the support surface. Thus, it is presumed that high activity is exhibited in a reforming reaction from the fact that the metal particles are fine.

In the catalyst, the amount (supported amount) of the metal particles is preferably 0.001% by mass to 20% by mass, is more preferably 0.01% by mass to 10% by mass, and is still more preferably 0.1% by mass to 5% by mass with respect to the support. When the amount of the metal particles is equal to or greater than the above-described lower limit value, the catalyst has higher activity in a reforming reaction. In addition, when the amount of the metal particles is equal to or less than the above-described upper limit value, the catalyst having a particle form with a small particle diameter is easily obtained. This is because it is possible to disperse a magnesia powder in an aqueous solution with a higher degree of dispersion in the method (impregnation method) of manufacturing a catalyst described below. Furthermore, such a catalyst having a particle form with a small particle diameter has a particularly high deposition suppressing effect with respect to a carbonaceous material on the surface thereof in a reforming reaction.

The amount of the metal particles, for example, is obtained by analyzing an object by fluorescent X-ray spectroscopy or atomic absorption spectrophotometry.

The support is formed of magnesia in which an aluminum-containing component is segregated on the surface. Here, the “aluminum-containing component” means a component including at least aluminum as a constituent element. The aluminum-containing component may be elemental aluminum (Al), and may be a component including aluminum and elements other than aluminum as constituent elements, such as alumina (aluminum oxide, Al₂O₃).

The aluminum-containing component may exist in a state where the aluminum-containing component is segregated on the support surface, that is, a greater amount of aluminum-containing component is present on the support surface than in the support and as a result, there is a clear deviation in the distribution thereof in the support.

The fact that the aluminum-containing component is segregated on the support surface can be confirmed, for example, by performing a composition analysis of the support surface by energy-dispersive X-ray spectroscopy (hereinafter, also referred to as “EDX”) and determining the distribution of aluminum.

As described above, the aluminum-containing component segregated on the support surface is presumed to have an action that decreases the particle diameter of the metal particles supported on the support.

The content of aluminum in the support is preferably 0.001% by mass to 10% by mass, is more preferably 0.01% by mass to 5% by mass, and is still more preferably 0.1% by mass to 3% by mass. When the amount of aluminum is in the above-described range, the catalyst has higher activity in a reforming reaction. The reason there is not clear, but it is presumed that the reason is because the metal particles supported on the support are brought into a sufficiently reduced state when a suitable amount of aluminum is present on the support surface.

The support preferably has a particle form, and the average particle diameter is preferably 50 nm to 5,000 nm, and is more preferably 100 nm to 3,000 nm. The average particle diameter value of the support is obtained by observing the support using an electron microscope, measuring the diameters (average value of a major axis and a minor axis) of 100 or more primary particles of the support, and calculating the arithmetic average.

Such a support having a particle form can be easily obtained, for example, if magnesia before the metal particles are supported is in the form of a powder. Here, both magnesia before a support is formed and magnesia forming a support are included in the “magnesia before the metal particles are supported”.

In a reforming reaction of reacting a reforming material including carbon dioxide and a hydrocarbon, the catalyst exhibits high activity, and has a high deposition suppressing effect with respect to carbonaceous material on the surface thereof. The reason why the deposition suppressing effect with respect to carbonaceous material is high is not clear, but is presumed to be as follows.

That is, the Literature “ACSNANO, Vol. 5, 3428 (2011)” discloses that growth of carbon nanotubes is overwhelmingly slower in a case where the support surface of a catalyst is acidic than in a case where the support surface of a catalyst is basic in the synthesis of carbon nanotubes by a catalytic chemical vapor growth method. On the other hand, it is presumed that in reforming reactions in the related art, fibrous carbon is produced on the catalyst surface as a carbonaceous material, and also in the catalyst according to the present invention, in the same manner as above, in a support in which a weakly acidic aluminum-containing component is segregated on the surface of strongly basic magnesia, the basicity of the surface is decreased by the presence of the aluminum-containing component, and due to this, deposition of a carbonaceous material is further suppressed than in a support in which an aluminum-containing component is not segregated.

<Method of Manufacturing Catalyst for Hydrocarbon Reforming>

(Impregnation Method)

The catalyst according to the present invention described above can be manufactured by impregnating a magnesia powder with an aqueous solution in which an aluminum salt, and at least one salt selected from a cobalt salt and a nickel salt are dissolved and drying the obtained impregnated material, baking the obtained dried material, and further reducing (the manufacturing method is also referred to as “impregnation method”).

The aqueous solution may be an aqueous solution in which an aluminum salt, and at least one salt (hereinafter, these salts are also referred to as “essential salts”) selected from a cobalt salt and a nickel salt are dissolved, and the dissolved salts may be only these essential salts (aluminum salt, cobalt salt, and nickel salt), and may be these essential salts and other salts (hereinafter, these salts are also referred to as “arbitrary salts”). As a preferred example of the above arbitrary salt, a magnesium salt can be exemplified.

Examples of the essential salts include carbonates, nitrates, nitrites, sulfates, sulfites, acetates, formates, phosphates, hydrogen phosphates, dihydrogen phosphates, a fluoride salt, a chloride salt, a bromide salt, an iodide salt, and a hydroxide salt. Among these, as the essential salts, nitrates, acetates, or carbonates are preferable since anionic components thereof are easily removed by heating, and nitrates are more preferable.

As the arbitrary salts, the same salts as the essential salts such as the above described carbonates and the like can be exemplified.

An aluminum salt, a cobalt salt, and a nickel salt may be used singly or in combination of two or more kinds thereof, respectively.

In addition, the above arbitrary salts may also be used singly or in combination of two or more kinds thereof, respectively.

The aqueous solution may include an organic solvent, the organic solvent is preferably a polar solvent, and examples of the polar solvent include amides such as N,N-dimethylformamide, N,N-diethylformamide, N,N-dimethylacetamide, and N-methyl-2-pyrrolidone; alcohols such as methanol, ethanol, and 2-propanol; and sulfoxides such as dimethyl sulfoxide.

The total concentration of aluminum salt, cobalt salt, and nickel salt (that is, essential salts) in the aqueous solution is preferably 0.001 mmol/L to 130 mmol/L, and is more preferably 0.1 mmol/L to 1.3 mmol/L. When the total concentration is in the above range, it is possible to easily dissolve these salts.

The temperature (liquid temperature) at the time of preparation of the aqueous solution may be room temperature, and in a case where the salt is less likely to be dissolved, heating may be suitably performed.

From the viewpoint of being capable of supporting a relatively large amount of the metal particles in a case of using a magnesia powder as a support, the magnesia powder preferably has a structure in which there are pores on the surface. Here, with the increase in the porosity (pore volume) of the magnesia powder (support), although the supported amount of the metal particles is increased, the strength of the support is decreased. Therefore, in consideration of the supported amount required for the metal particles and the strength of the support, the porosity of the magnesia powder is preferably suitably adjusted.

In the impregnation method, first, a magnesia powder is impregnated with the aqueous solution, whereby an impregnated material is obtained. In order to impregnate the magnesia powder with the aqueous solution, the aqueous solution may be brought into contact with the magnesia powder; however, it is preferable to apply any one of a method of dipping the magnesia powder in the aqueous solution and a method of dispersing the magnesia powder into the aqueous solution. Furthermore, in a case of dispersing the magnesia powder into the aqueous solution, it is preferable to disperse while irradiating with ultrasonic waves or microwaves.

The temperature of the aqueous solution at the time of impregnation may be room temperature, and heating may be suitably performed.

The conditions (impregnation conditions) for impregnating the magnesia powder with the aqueous solution are preferably determined by adjusting conditions such as the amounts of the aluminum salt, the cobalt salt, and the nickel salt used, the concentration of the aqueous solution, the temperature, and the impregnation time such that the amount (supported amount) of the metal particles in the catalyst becomes a desired value, depending on the type of salts to be used and the impregnation method.

For example, the impregnation time is preferably 1 minute to 1 week, is more preferably 1 hour to 120 hours, and is still more preferably 2 hours to 72 hours.

In the impregnation method, next, the obtained impregnated material is dried, whereby a dried material is obtained.

Drying of the impregnated material is preferably performed by heating, and the heating temperature at this time is not particularly limited, however, since evaporation of a solvent component is further accelerated as the temperature becomes higher and due to this, the processing time is shortened, the heating temperature is preferably equal to or higher than 100° C. In addition, sufficient drying of the impregnated material is preferably performed until change in weight of the dried material is not observed. By sufficiently drying in such a manner, a portion of crystallization water is also removed from the dried material, and the change in volume at the time of subsequent baking is reduced. In contrast, when drying is not sufficient, there is a concern that bumping of the residual water in the dried material or contraction of the dried material is likely to occur at the time of baking, which may cause a structure collapse. For example, whether or not the solvent component has been completely removed can be determined from the weight loss value of the impregnated material due to drying.

In the impregnation method, next, the obtained dried material is baked. By baking, a solvent component and an anionic component of the salt (essential salts, arbitrary salts) are removed from the dried material, whereby a baked material corresponding to a catalyst precursor is obtained. The baked material is activated by a reduction treatment described below, as a result, the catalyst is obtained, and it is presumed that a solid solution (composite oxide) including aluminum in the magnesia and cobalt or nickel is formed.

Baking is performed in an oxidizing atmosphere such as air.

The baking temperature, which is not particularly limited, is preferably 700° C. to 1,300° C. When the baking temperature is equal to or higher than 700° C., removal of the anionic component of the salts and generation of the composite oxide proceeds rapidly. In addition, when the baking temperature is equal to or lower than 1,300° C., since the surface area of the obtained catalyst increases, the obtained catalyst has higher activity.

The baking time is preferably 1 hour to 20 hours. When the baking time is equal to or greater than 1 hour, removal of the anionic component of the salt and generation of the composite oxide proceeds rapidly. In addition, when the baking time is equal to or less than 20 hours, the obtained catalyst has higher activity.

In the impregnation method, next, the obtained baked material is further reduced. Thus, the activated catalyst is obtained. It is presumed that by reduction of the baked material, cobalt or nickel dissolved in the magnesia emerge to the surface of the magnesia, and functions as an active component of the catalyst.

Reduction is performed by heating the baked materials in the presence of a reducing gas such as hydrogen gas. At that time, the reducing gas may be diluted with an inert gas such as nitrogen gas or the like.

The reduction temperature (heating temperature) is preferably 500° C. to 1,000° C., is more preferably 600° C. to 1,000° C., and is still more preferably 650° C. to 1,000° C.

The reduction time is preferably 0.5 hours to 50 hours.

Reduction of the baked material is performed in a reactor for performing a reforming reaction described below, and the reduction and the reforming reaction may also be continuously performed.

(Spraying Method)

The catalyst according to the present invention described above can also be manufactured by spraying an aqueous solution in which a magnesium salt, an aluminum salt, and at least one salt selected from a cobalt salt and a nickel salt are dissolved and further reducing the powder synthesized by heating the obtained liquid droplets (the manufacturing method is also referred to as “spraying method”).

The aqueous solution in the spraying method may be an aqueous solution in which a magnesium salt, an aluminum salt, and at least one salt selected from a cobalt salt and a nickel salt (in the same manner as in the case of the impregnation method, hereinafter, these salts are also referred to as “essential salts”) are dissolved, the dissolved salts may be only these essential salts (magnesium salt, aluminum salt, cobalt salt, and nickel salt), and may be these essential salts and other salts (in the same manner as in the case of the impregnation method, hereinafter, these salts are also referred to as “arbitrary salts”).

The total concentration of magnesium salt, aluminum salt, cobalt salt, and nickel salt (that is, essential salts) in the aqueous solution in the spraying method is preferably 100 mmol/L to 5,000 mmol/L, and is more preferably 500 mmol/L to 2,000 mmol/L. When the total concentration in the spraying method is in the above range, it is possible to easily dissolve these salts.

The temperature (liquid temperature) at the time of preparation of the aqueous solution may be room temperature, and in a case where the salts are less likely to be dissolved, heating may be suitably performed.

Examples of the essential salts in the spraying method include carbonates, nitrates, nitrites, sulfates, sulfites, acetates, formates, phosphates, hydrogen phosphates, dihydrogen phosphates, a fluoride salt, a chloride salt, a bromide salt, an iodide salt, and a hydroxide salt. Among these, as the essential salts in the spraying method, nitrates, acetates, or carbonates are preferable since anionic components thereof are easily removed by heating, and nitrates are more preferable.

As the arbitrary salts in the spraying method, the same salts as the essential salts in the spraying method such as the above described carbonates and the like can be exemplified.

A magnesium salt, an aluminum salt, a cobalt salt, and a nickel salt may be used singly or in combination of two or more kinds thereof, respectively.

In addition, the above arbitrary salts may also be used singly or in combination of two or more kinds thereof, respectively.

The aqueous solution in the spraying method may include an organic solvent, the organic solvent is preferably a polar solvent, and examples of the polar solvent include amides such as N,N-dimethylformamide, N,N-diethylformamide, N,N-dimethylacetamide, and N-methyl-2-pyrrolidone; alcohols such as methanol, ethanol, and 2-propanol; and sulfoxides such as dimethyl sulfoxide.

In the spraying method, first, the aqueous solution is sprayed, and the obtained liquid droplets are heated, whereby a powder which is a catalyst is synthesized. The catalyst is subjected to a reduction treatment described below, and as a result, the catalyst is further activated.

The liquid droplets are fine, and spraying of the aqueous solution may be performed, for example, by a known method such as a method of atomizing using an ultrasonic nebulizer.

In order to synthesize the powder, the liquid droplets may be heated, but it is preferable to heat the liquid droplets by spraying the aqueous solution to the heated reaction vessel.

The heating conditions of the liquid droplets are preferably determined by adjusting conditions such as the amounts of magnesium salt, aluminum salts, cobalt salt, and nickel salt used, the concentration of the aqueous solution, the heating temperature, and the heating time such that the content (supported amount) of the metal particles in the catalyst becomes a desired value, depending on the type of the salt to be used and the heating method.

The heating temperature (in a case of using the reaction vessel, the temperature of the reaction vessel) of the liquid droplets is preferably 800° C. to 1,500° C.

In a case of using a carrier gas at the time of heating the liquid droplets, an inert gas such as nitrogen or the like is preferably used, however, air may also be used as a carrier gas.

Although the flow velocity of the carrier gas is not particularly limited, for example, the flow velocity is 0.1 L/min to 50 L/min, and more specifically, may be about 1.0 L/min to 30 L/min.

In the spraying method, next, the obtained powder (catalyst) is further reduced. Thus, the activated catalyst is obtained.

Reduction is performed by heating the powder in the presence of a reducing gas such as hydrogen gas. At that time, the reducing gas may be diluted with an inert gas such as nitrogen gas or the like.

The reduction temperature (heating temperature) is preferably 500° C. to 1,000° C., is more preferably 600° C. to 1,000° C., and is still more preferably 650° C. to 1,000° C.

The reduction time is preferably 0.5 hours to 50 hours.

Reduction of the powder is performed in a reactor for performing a reforming reaction described below, and the reduction and the reforming reaction may also be continuously performed.

<Method of Manufacturing Synthesis Gas>

The method of manufacturing a synthesis gas according to the present invention is a method of obtaining a synthesis gas including carbon monoxide and hydrogen from hydrocarbons and a reforming material including carbon dioxide using the catalyst according to the present invention.

In the manufacturing method, in a case of using the catalyst obtained by the impregnation method or the spraying method described above, it is preferable to use the catalyst immediately after the reductions (reduction of the baked material in the impregnation method, reduction of the powder in the spraying method) in these methods.

In the manufacturing method, for example, the raw material gas including hydrocarbons and a reforming material is supplied to the catalyst (catalyst layer in the reaction tube) filled into the reaction tube, and the reforming reaction is performed under arbitrary conditions, whereby a synthesis gas is obtained.

As the hydrocarbons, for example, hydrocarbons obtained from natural gas, petroleum gas, naphtha, heavy oil, crude oil, coal, coal sand, or the like can be used, and may be used singly or in combination of two or more kinds thereof. Among these, the hydrocarbon is preferably methane.

The reforming material may be a reforming material including carbon dioxide, may be only carbon dioxide, and may be a mixture including carbon dioxide and components other than carbon dioxide. As components other than carbon dioxide, water (water vapor), air, and oxygen can be exemplified, and water is preferable.

The amount of carbon dioxide in the reforming material is preferably 30 mol % to 100 mol %, is more preferably 50 mol % to 100 mol %, is still more preferably 80 mol % to 100 mol %, and is particularly preferably 100 mol %, that is, a case of using only carbon dioxide as the reforming material. When the amount of carbon dioxide is in the above range (value), a molar ratio of hydrogen (H₂)/carbon monoxide (CO) is relatively low, and a synthesis gas having excellent usability is obtained.

When the reforming reaction is performed, a hydrocarbon and a reforming material are supplied such that the reforming material/hydrocarbon (molar ratio) preferably becomes 0.3 to 100, more preferably becomes 0.3 to 10, and still more preferably becomes 0.5 to 3. When the molar ratio is equal to or greater than 0.3, the deposition suppressing effect of carbonaceous material on the catalyst surface becomes higher, and when the molar ratio is equal to or less than 100, a large reaction tube is not required, and thus, it is possible to reduce the amount that needs to be invested in facilities.

The raw material gas may include an inert gas such as nitrogen gas or the like as a dilution gas other than a hydrocarbon and a reforming material.

The reaction temperature when the reforming reaction is performed is preferably 500° C. to 1,000° C., is more preferably 600° C. to 1,000° C., and is still more preferably 650° C. to 1,000° C. When the reaction temperature is equal to or higher than 500° C., the conversion ratio of the hydrocarbon is improved, and thus, is more practical, and when the reaction temperature is equal to or lower than 1,000° C., a reaction tube having high-temperature resistance is not required, and thus, it is possible to reduce the amount that needs to be invested in facilities.

The pressure when the reforming reaction is performed may be adjusted such that the gauge pressure preferably becomes 0.1 MPa to 10 MPa, more preferably becomes 0.1 MPa to 5 MPa, and still more preferably becomes 0.1 MPa to 3 MPa. When the gauge pressure is equal to or greater than 0.1 MPa, a large reaction tube is not required, and thus, it is possible to reduce the amount that needs to be invested in facilities, and when the gauge pressure is equal to or less than 10 MPa, a reaction tube having high-pressure resistance is not required, and thus, it is possible to reduce the amount that needs to be invested in facilities.

The gas hourly space velocity (GHSV, value obtained by dividing the supply rate of the raw material gas by the amount of catalyst in terms of volume) of the raw material gas is preferably 500 h⁻¹ to 200,000 h⁻¹, is more preferably 1,000 h⁻¹ to 100,000 h⁻¹, and is still more preferably 1,000 h⁻¹ to 75,000 h⁻¹.

As the shape of the catalyst bed, it is possible to arbitrarily select a well-known shape such as a fixed bed, a moving bed, a fluidized bed, or the like.

According to the method of manufacturing a synthesis gas of the present invention, in the reforming reaction, the deposition of carbonaceous material on the catalyst surface is suppressed, and thus, it is possible to maintain the high activity of the catalyst for a long period of time. In addition, the deposition of carbonaceous material on the catalyst surface is suppressed, and due to this, clogging of the catalyst, breakage of the catalyst layer, or the like is also suppressed, and thus, decrease in the proportion of the catalyst contributing to the reforming reaction by drift of the gas in the reaction zone is also suppressed. Therefore, it is possible to efficiently perform the reforming reaction for a long period of time. From the viewpoint that such excellent effects are significantly exhibited even in a case of using a reforming material having a high carbon dioxide content, in particular, a reforming material formed of only carbon dioxide, the method of manufacturing a synthesis gas according to the present invention is excellent.

The molar ratio of hydrogen/carbon monoxide in the synthesis gas can be suitably adjusted by adjusting the conditions of the reforming reaction, and for example, a synthesis gas having the molar ratio of 1 to 2 which is suitable for manufacture of light hydrocarbons by the Fischer-Tropsch reaction can be easily obtained.

### EXAMPLES

Hereinafter, the present invention will be described in more detail according to specific Examples. However, the present invention is not limited to the Examples described below.

### Manufacture of Catalyst

### Impregnation Method

### Example 1

Cobalt nitrate hexahydrate (Co(NO₃)₂.6H₂O) (1.02 g) and aluminum nitrate nonahydrate (Al(NO₃)₃.9H₂O) (2.99 g) were dissolved in water (100 mL), whereby an aqueous solution was prepared.

Magnesia powder (manufactured by Ube Material Industries) (20 g) was added to the obtained aqueous solution, followed by dispersing (suspending) for 3 hours, and the obtained dispersion was evaporated to dryness. Moreover, the above described average particle diameter of the magnesia powder was 1.9 μm to 2.3 μm.

Then, the obtained dried solid material was baked at 1,100° C. for 5 hours in the atmosphere, whereby a baked material A′ was obtained (yield: 20 g).

The obtained baked material A′ (20 g) was subjected to a reduction treatment at 900° C. for 20 hours in a hydrogen gas atmosphere, whereby a catalyst A in which cobalt particles were supported on a support in which aluminum was segregated on the surface of magnesia was obtained (yield: 20 g). As shown in Table 1, in the catalyst A, the amount of the cobalt particles was 1% by mass with respect to the support, and the amount of aluminum in the support was 1% by mass. In Table 1, “1% by mass” regarding the cobalt particles (metal particles) means the amount of the cobalt particles with respect to the support, and “1% by mass” regarding aluminum means the amount of the aluminum in the support. This is the same in the following Examples and Comparative Examples.

### Example 2

A baked material B′ and a catalyst B were obtained in the same manner as in Example 1 except that the amount of aluminum nitrate nonahydrate used was changed from 2.99 g to 0.29 g. The catalyst B was a catalyst in which cobalt particles were supported on a support in which aluminum was segregated on the surface of magnesia, and as shown in Table 1, the amount of the cobalt particles was 1% by mass with respect to the support, and the amount of aluminum in the support was 0.1% by mass.

### Example 3

A baked material C′ and a catalyst C were obtained in the same manner as in Example 1 except that the amount of aluminum nitrate nonahydrate used was changed from 2.99 g to 9.72 g. The catalyst C was a catalyst in which cobalt particles were supported on a support in which aluminum was segregated on the surface of magnesia, and as shown in Table 1, the amount of the cobalt particles was 1% by mass with respect to the support, and the amount of aluminum in the support was 3% by mass.

### Example 4

A baked material D′ and a catalyst D were obtained in the same manner as in Example 1 except that the amount of cobalt nitrate hexahydrate used was changed from 1.02 g to 2.07 g and the amount of aluminum nitrate nonahydrate used was changed from 2.99 g to 3.03 g. The catalyst D was a catalyst in which cobalt particles were supported on a support in which aluminum was segregated on the surface of magnesia, and as shown in Table 1, the amount of the cobalt particles was 2% by mass with respect to the support, and the amount of aluminum in the support was 1% by mass.

### Example 5

A baked material E′ and a catalyst E were obtained in the same manner as in Example 1 except that nickel nitrate hexahydrate (Ni(NO₃)₂.6H₂O) (1.02 g) was used instead of cobalt nitrate hexahydrate (1.02 g). The catalyst E was a catalyst in which nickel particles were supported on a support in which aluminum was segregated on the surface of magnesia, and as shown in Table 1, the amount of the nickel particles was 1% by mass with respect to the support, and the amount of aluminum in the support was 1% by mass.

### Comparative Example 1

A baked material a′ and a catalyst a were obtained in the same manner as in Example 1 except that aluminum nitrate nonahydrate was not used. The catalyst a was a catalyst in which cobalt particles were supported on a support formed of magnesia, and as shown in Table 1, the amount of the cobalt particles was 1% by mass with respect to the support, and aluminum was not contained therein.

### Comparative Example 2

A baked material b′ and a catalyst b were obtained in the same manner as in Example 1 except that the amount of cobalt nitrate hexahydrate used was changed from 1.02 g to 5.10 g and aluminum nitrate nonahydrate was not used. The catalyst b was a catalyst in which cobalt particles were supported on a support formed of magnesia, and as shown in Table 1, the amount of the cobalt particles was 5% by mass with respect to the support, and aluminum was not contained therein.

### Manufacture of Synthesis Gas

### Example 6

A circulation type reaction tube having an inner diameter of 7.0 mm was filled with the catalyst A (0.4 g) to form a catalyst layer having a volume of 1.1 cm³, and the catalyst layer was subjected to a reduction treatment at 850° C. for 1 hour while supplying hydrogen gas thereto.

Then, while maintaining the outlet temperature of the circulation type reaction tube at 850° C. and the ambient pressure (gauge pressure) of the circulation type reaction tube at 1.0 MPa, respectively, a mixed gas of carbon dioxide/methane=1 (molar ratio) as the raw material gas was supplied to the catalyst layer in the circulation type reaction tube under the condition of a gas hourly space velocity (GHSV) of 3000 h⁻¹, and a reforming reaction was performed while this state was maintained for 20 hours.

As a result, a synthesis gas having a molar ratio of hydrogen/carbon monoxide of 0.8 was obtained in accordance with approximately the theoretical value. Furthermore, a methane conversion ratio and a carbonaceous material deposition rate on the catalyst surface were calculated by the following method. The results are shown in Table 1.

(Methane Conversion Ratio)

The methane concentration in the raw material gas and the methane concentration in the reaction gas at the outlet of the catalyst layer were measured using gas chromatography, and the methane conversion ratio (%) was calculated by the following equation (i) by using these measured values. Table 1 shows a value calculated by using the methane concentration in the reaction gas for 20 hours after the start of the reaction.

[Methane conversion ratio (%)]={[methane concentration in the raw material gas]×[flow rate of the raw material gas at the inlet of the catalyst layer]−[methane concentration in the reaction gas]×[gas flow rate at the outlet of the catalyst layer]}/[methane concentration in the raw material gas]×[flow rate of the raw material gas at the inlet of the catalyst layer]×100 (i)

(Carbonaceous Material Deposition Rate)

The catalyst was taken out from the circulation type reaction tube after the reforming reaction, the amount of the carbonaceous material deposited on the catalyst surface was measured by thermogravimetry by temperature-programmed oxidation, and a value obtained by dividing the mass ratio (% by weight) with respect to the total amount of catalyst including the carbonaceous material after the reforming reaction by the reaction time (h) was used as a carbonaceous material deposition rate (% by weight/h). The measurement conditions of the amount of the carbonaceous material at this time were as follows.

Measurement conditions: A quartz tube was filled with 0.05 g of a catalyst including the carbonaceous material after the reforming reaction, and was fixed with quartz wool. A mixed gas of 4.98% oxygen and argon was flowed thereto at a flow velocity of 28.5 mL/min, and the temperature was raised from room temperature to 1,000° C. at a temperature raising rate of 10° C./min. Carbon monoxide (CO) and carbon dioxide (CO₂) generated at this time were turned into methane (CH₄) using a methanizer, and quantitative analysis was performed using a GC-FID (GC-8A, manufactured by Shimadzu Corporation), using hydrogen (H₂) gas as a carrier gas.

### Examples 7 to 10 and Comparative Examples 3 to 4

As shown in Table 1, the reforming reaction was performed in the same manner as in Example 6 except that any one of the catalysts 13 to E and a and b was used instead of the catalyst A, and the methane conversion ratio and the carbonaceous material deposition rate were calculated. The results are shown in Table 1.

TABLE 1

| | | | Carbonaceous |
|---|---|---|---|
| | | Methane | material depo- |
| | | conversion | sition rate (% |
| | Catalyst | ratio (%) | by weight/h) |
| Example 6 | Catalyst A (Co: 1% by | 68 | <0.3 |
| | weight, Al: 1% by weight) | | |
| Example 7 | Catalyst B (Co: 1% by | 68 | <0.3 |
| | weight, Al: 0.1% by weight) | | |
| Example 8 | Catalyst C (Co: 1% by | 69 | <0.5 |
| | weight, Al: 3% by weight) | | |
| Example 9 | Catalyst D (Co: 2% by | — | — |
| | weight, Al: 1% by weight) | | |
| Example 10 | Catalyst E (Ni: 1% by | 69 | — |
| | weight, Al: 1% by weight) | | |
| Comparative | Catalyst a (Co: 1% by | 10 | 6 |
| Example 3 | weight, Al: 0% by weight) | | |
| Comparative | Catalyst b (Co: 5% by | — | — |
| Example 4 | weight, Al: 0% by weight) | | |

As apparent from the above results, in Examples 6 to 10 in which the reforming reaction of methane was performed using a catalyst in which aluminum was segregated on the support surface as a catalyst, the methane conversion ratio was equal to or greater than 68%, which is a sufficiently high value. In addition, regardless of using only carbon dioxide as a reforming material, the carbonaceous material deposition rate was equal to or less than 0.5% while the equilibrium conversion ratio was maintained under these conditions, and the deposition suppressing effect with respect to carbonaceous material on the catalyst surface was high.

In contrast, in Comparative Examples 3 and 4 in which aluminum was not used, and then, a catalyst in which aluminum was not segregated on the support surface was used, the methane conversion ratio was only a maximum of 10%, the carbonaceous material deposition rate was a minimum of 6%, which was faster, and a larger amount of carbonaceous material was deposited on the catalyst surface.

### Manufacture (Spraying Method) and Evaluation of Catalyst

### Example 11

Magnesium nitrate hexahydrate (912.0 g), cobalt nitrate hexahydrate (14.8 g), and aluminum nitrate nonahydrate (20.9 g) were dissolved in water (3 L), whereby a mixed aqueous solution having a concentration of about 50 g/L in terms of a catalyst powder having a composition of “2% by weight of Co/MgO+1% by weight of Al” was prepared. The mixed aqueous solution was atomized using an ultrasonic nebulizer, and fed into a ceramic reaction tube (inner diameter of 50 mm, length of 1,000 mm) heated to 1,000° C. in an electric furnace using air having a flow velocity of 10 L/min as a carrier gas. While passing through the reaction tube, water was evaporated from the mist of the mixed aqueous solution, and the powder generated by precipitation and thermal decomposition of the raw material compound was collected using a cyclone provided on the downstream side with respect to the reaction tube. As a result of performing analysis on the generated powder by a powder X-ray diffraction method, peaks derived from oxides of cobalt or aluminum was not observed, and only the pattern of a rock salt type crystal structure corresponding to MgO was observed.

The generated powder was graded such that the particle diameter thereof became 250 μm to 500 μm, a hydrogen reduction treatment was performed thereon at 900° C. for 20 hours, and the activity of the catalyst was measured at 850° C. As a result, it was confirmed that a high methane conversion ratio substantially equal to the equilibrium value of the catalyst was exhibited. In addition, the amount of carbonaceous material deposited on the catalyst surface after the activity measurement was equal to or less than 0.1% by weight/h, which was extremely small, and the deposition suppressing effect of carbonaceous material on the catalyst surface was high.

### Test Example 1

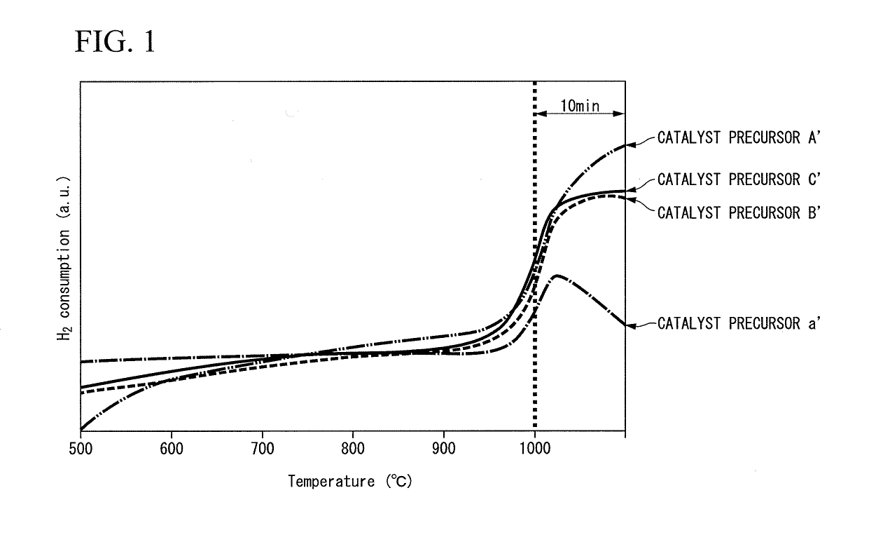

In order to compare the degree of reduction of the metal particles in the catalyst, analysis by a temperature-programmed reduction (TPR) was performed on the baked materials A′ to C′ in Examples 1 to 3 and the baked material a′ in Comparative Example 1 in the presence of hydrogen under the following conditions. The results are shown in FIG. 1. Moreover, in FIG. 1, the vertical axis “H₂ consumption (a.u.)” means the amount of hydrogen consumption, and the horizontal axis “Temperature (° C.)” means the temperature at the time of reduction.

(TPR Analysis Conditions)

A quartz tube was filled with 0.1 g of each baked material described above, and was fixed with quartz wool. A mixed gas of 4.94% hydrogen and argon was flowed thereto at a flow velocity of 32.4 mL/min, and the temperature was raised from room temperature to 1,000° C. at a temperature raising rate of 10° C./min. The amount of hydrogen consumption at this time was measured using a GC-TCD (GC-8A, manufactured by Shimadzu Corporation), using the mixed gas of 4.94% hydrogen and argon as a carrier gas.

As shown in FIG. 1, in the baked materials A′ to C′ in Examples 1 to 3 in which aluminum was used, a large amount of hydrogen was consumed at the temperature equal to or higher than 1,000° C. It is believed that since in the catalysts A to C of Examples 1 to 3, the metal particles were sufficiently reduced, the catalysts A to C of Examples 1 to 3 exhibited high activity in the reforming reactions of Examples 6 to 8. It is believed that the catalysts D and E of Examples 4 and 5 also exhibited high activity in the reforming reactions of Examples 8 and 9 for the same reason as the above cases.

In contrast, in the baked material a′ in Comparative Example 1 in which aluminum was not used, an extremely small amount of hydrogen was consumed even at the temperature equal to or higher than 1,000° C. It is believed that since in the catalyst a of Comparative Example 1, the reduction of the metal particles was not sufficient, the catalyst a exhibited low activity in reforming in Comparative Example 3.

### Test Example 2

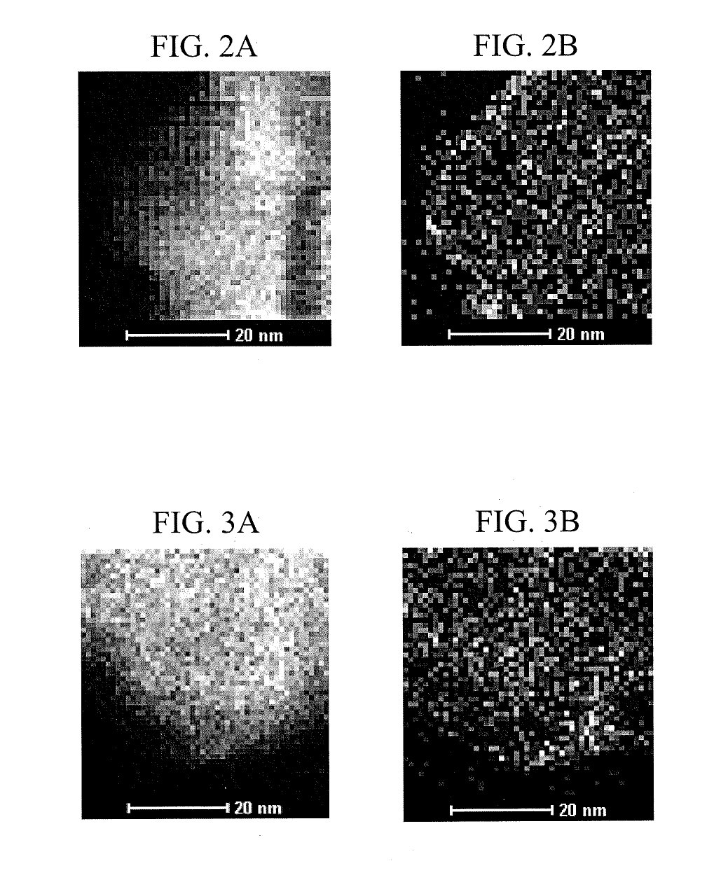

Composition analysis was performed on the catalysts D and E of Examples 4 and 5 by EDX under the following conditions. The distribution diagrams of magnesium and aluminum in the catalyst D are shown in FIGS. 2A and 2B, and the distribution diagram of magnesium and aluminum in the catalyst E is shown in FIG. 3, respectively. In addition, FIG. 2A is a distribution diagram of magnesium in the catalyst D, and FIG. 2B is a distribution diagram of aluminum in the catalyst D. In addition, FIG. 3A is a distribution diagram of magnesium in the catalyst E, and FIG. 3B is a distribution diagram of aluminum in the catalyst E.

(EDX Analysis Conditions)

Electron microscope analyzer: TITAN 80-300 (manufactured by FEI)

Accelerating voltage: 200 kV

EDX surface analysis: Number of pixels of 100 pixels×100 pixels

In FIGS. 2A and 2B, the support surface of the catalyst is present on the left side of the paper. Furthermore, magnesium was distributed over the entire support, as shown in FIG. 2A, and in contrast, aluminum was segregated on the support surface or in the vicinity thereof, as shown in FIG. 2B.

On the other hand, in FIGS. 3A and 3B, the support surface of the catalyst is present on the lower side of the paper. Furthermore, magnesium was distributed over the entire support, as shown in FIG. 3A, and in contrast, aluminum was segregated on the support surface or in the vicinity thereof, as shown in FIG. 3B.

### Test Example 3

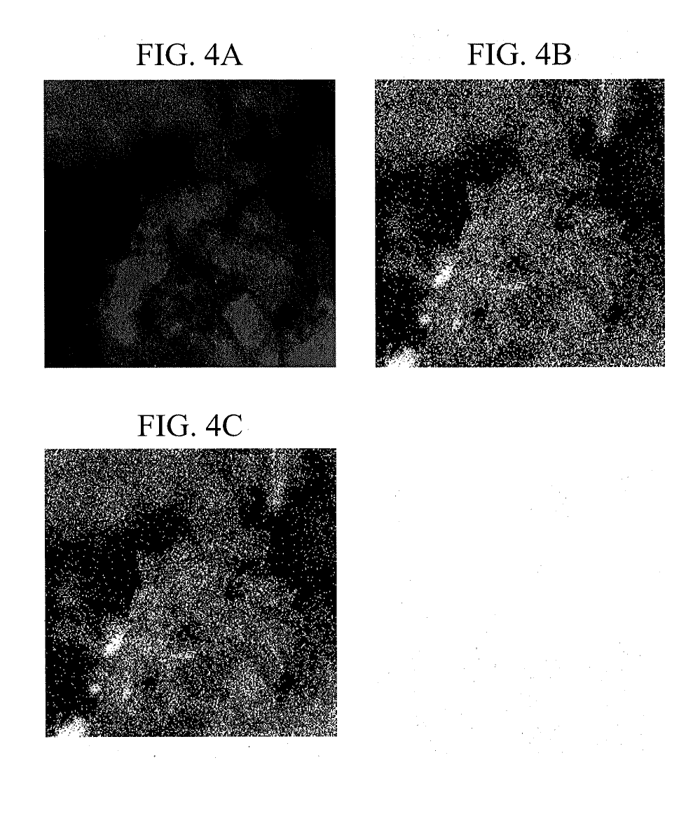

Composition analysis was performed on the baked material C′ of Example 3 by EDX under the following conditions. The distribution diagrams of magnesium and aluminum in the baked material C′ are shown in FIGS. 4A, 4B, and 4C. FIG. 4A is the distribution diagram of magnesium in the baked material C′, FIG. 4B is the distribution diagram of aluminum in the baked material C′, and FIG. 4C is the diagram obtained by superimposing the distribution diagram of magnesium and the distribution diagram of aluminum.

(EDX Analysis Conditions)

Electron microscope analyzer: Transmission electron microscope JEM-ARM200F (manufactured by JEOL, Ltd.)

Accelerating voltage: 120 kV

EDX surface analysis: Number of pixels of 256 pixels×256 pixels

Energy dispersive X-ray analyzer: JED-2300T (manufactured by JEOL, Ltd.)

Detector: Dry SD100GV (manufactured by JEOL, Ltd.)

In FIG. 4A, the shape of the magnesia particles is clearly shown. In addition, in FIG. 4B, it is shown that along the contour of the magnesia particles, aluminum was segregated. In particular, it can be seen that aluminum was linearly segregated in the central lower left area of the paper, however, when observing in conjunction with FIG. 4A, it is clear that magnesia particles are present inside the baked material C′. It is presumed that this is because aluminum was detected in a high concentration due to irradiating the surface of the magnesia particles in which aluminum was segregated on the surface thereof with X-rays. Moreover, when observing the distributions of magnesium and aluminum in FIG. 4C, it is further clear that aluminum was segregated on the surface of the magnesia.

### Test Example 4

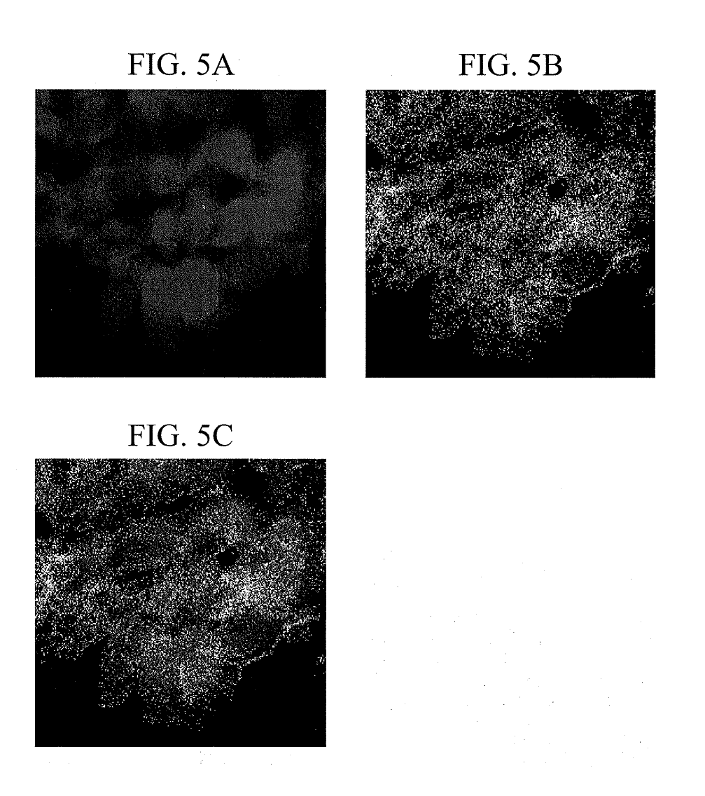

Composition analysis was performed on the baked material A′ of Example 1 by EDX under the same conditions as in Test Example 3. The distribution diagrams of magnesium and aluminum in the baked material A′ are shown in FIGS. 5A, 5B, and 5C. FIG. 5A is the distribution diagram of magnesium in the baked material A′, FIG. 5B is the distribution diagram of aluminum in the baked material A′, and FIG. 5C is the diagram obtained by superimposing the distribution diagram of magnesium and the distribution diagram of aluminum.

In FIG. 5A, the shape of the magnesia particles is clearly shown. In addition, in FIG. 5B, it is shown that along the contour of the magnesia particles, aluminum was segregated. In particular, it can be seen that aluminum was linearly segregated from the center to the lower right side of the paper, however, when observing in conjunction with FIG. 5A, it is clear that magnesia particles are present inside the baked material A′. It is presumed that this is because aluminum was detected in a high concentration due to irradiating the surface of the magnesia particles in which aluminum was segregated on the surface thereof with X-rays.

The present invention can be used in manufacture of a synthesis gas by reforming hydrocarbons, the synthesis gas can be used in manufacture of hydrocarbons or the like, and utility value thereof is extremely high.

While preferred embodiments of the invention have been described and shown above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A catalyst for hydrocarbon reforming, which is used for reforming hydrocarbons by a reaction of the hydrocarbons and a reforming material including carbon dioxide,
wherein at least one type of metal particles selected from cobalt particles and nickel particles is supported on a support formed of magnesia in which an aluminum-containing component is segregated on the surface.

2. The catalyst for hydrocarbon reforming according to claim 1,
wherein the amount of the metal particles is 0.001% by mass to 20% by mass with respect to the support.

3. The catalyst for hydrocarbon reforming according to claim 1,
wherein the amount of aluminum in the support is 0.001% by mass to 10% by mass.

4. The catalyst for hydrocarbon reforming according to claim 1,
wherein the magnesia before the metal particles are supported is in the form of a powder.

5. A method of manufacturing the catalyst for hydrocarbon reforming according to claim 1,
wherein a magnesia powder is impregnated with an aqueous solution in which an aluminum salt and at least one salt selected from a cobalt salt and a nickel salt are dissolved, the obtained impregnated material is dried, and the obtained dried material is baked and further reduced.

6. A method of manufacturing the catalyst for hydrocarbon reforming according to claim 1,
wherein an aqueous solution in which a magnesium salt, an aluminum salt, and at least one salt selected from a cobalt salt and a nickel salt are dissolved is sprayed, and a powder synthesized by heating the obtained liquid droplets is further reduced.

7. A method of manufacturing a synthesis gas,
wherein using the catalyst for hydrocarbon reforming according to claim 1, a synthesis gas including carbon monoxide and hydrogen is obtained from hydrocarbons and a reforming material including carbon dioxide.

8. The method of manufacturing a synthesis gas according to claim 7,
wherein only carbon dioxide is used as the reforming material.

9. The method of manufacturing a synthesis gas according to claim 7,
wherein the hydrocarbons and the reforming material are supplied such that the reforming material/the hydrocarbons (molar ratio) becomes 0.3 to 10.

10. The method of manufacturing a synthesis gas according to claim 7,
wherein the hydrocarbon is methane.
